(19) United States
(12) Patent Application Publication
(10) Pub. No.: US 2006/0199623 A1
(43) Pub. Date: Sep. 7, 2006

(54) Mobile phone push button

(76) Inventor: Shih-Yang Chan, Tucheng City (TW)

Correspondence Address: LEONG C LEI, PMB # 1008, 1867 YGNACIO VALLEY ROAD, WALNUT CREEK, CA, 94598, US

(21) Appl. No.: 11/072,424

(22) Filed: Mar. 7, 2005

(51) Int. Cl. H04M 1/00; H04B 1/38

(52) U.S. Cl. 455/575.1; 455/550.1

(57) ABSTRACT

A mobile phone push button has a slot exactly following the shape of the letter/pattern designated respectively for each of those push buttons on a mobile phone; the slot entirely or partially penetrating through the push button, then filled up with a second material; the second material being fluorescent material or a material pervious to light to display in the darkness the function represented by that push button and ensure of colorfastness of the letter/pattern assigned to the push button.

### BACKGROUND OF THE INVENTION

(a) Technical Field of the Invention

The present invention is related to a push button on a mobile phone, and more particularly, to one that has its letter/pattern engraved into a slot with the slot entirely or partially penetrating through the block of the push button and the slot is with a colorfast material in a color different from that of the push button to highlight the letter/pattern.

(b) Description of the Prior Art

As the mobile phone becomes very popular, user enjoys more convenient communication in daily life by operating the push buttons on the mobile phone either for dialing a call, transmitting a message, or executing other functions.

Each of the push buttons on the mobile phone is generally made of plastic material and the letter/pattern representing the respectively designated function is printed on the corresponding push button for the user to identify the function represented by each push button. However, the letter or pattern after a given time is vulnerable to be stripped off or discolored to make it impossible for identification while showing unpleasant appearance of the mobile phone.

### SUMMARY OF THE INVENTION

The primary purpose of the present invention is to provide a mobile phone push button that is illuminated in the darkness to display their respectively designated letters/patterns and functions.

Another purpose of the present invention is to provide a mobile phone push button that permits the light from an illuminating device, such as an LED disposed in the mobile phone to display the letter/pattern of each push button.

Another purpose yet of the present invention is to provide mobile phone push button that the letter/pattern will not be stripped off or discolored after use for a longer time.

To achieve these purposes, the letter/pattern designating the function of each push button is engraved into a slot that partially or entirely penetrates the block of the push button, and a second material is filled in the slot. The color of the second material is different from that of the block of the push button and may be of a fluorescent material to permit the light from the LED to pass through the block of the push button. Since the letter/pattern is formed by filling the second material into the slot of each push button, it will not be vulnerable to discoloration or fading off as found with the prior art after a longer time of use.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a layout of a first preferred embodiment of the present invention applied on a mobile phone.

FIG. 2 is a perspective view of the first preferred embodiment of the present invention.

FIG. 3 is a sectional view in the direction of 3-3 as cut away from the first preferred embodiment illustrated in FIG. 2.

FIG. 4 is a sectional view showing a local part of a second preferred embodiment of the present invention.

FIG. 5 is a sectional view showing a third preferred embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

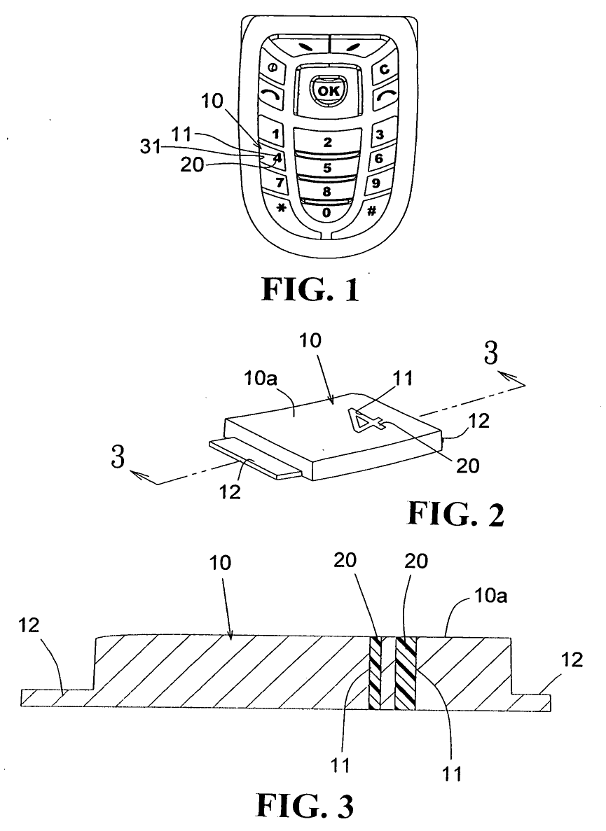

Referring to FIGS. 1 through 5, the present invention is comprised of a push button block (10), an engraved slot (11) in the form of a letter/pattern designated to the push button, and a second material (2) filled in the slot (11).

The block (10) of the push button is made of ceramic or metal material, and a tongue (12) respectively extends from the shorter sides of the block (10). The tongue (12) is retained by the inner side of a recess (31) reserved on the case of the mobile phone to allow the block (10) firmly slide into the recess (31).

As illustrated in FIG. 5, the slot (11) is made into a conic shape to prevent escape of the second material (20) filled in the slot (10).

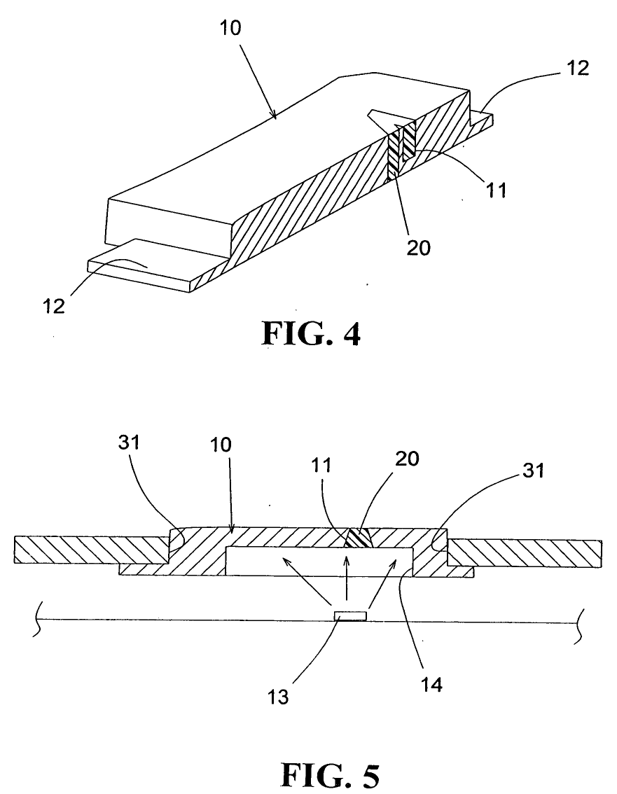

The slot (11) is engraved from an upper surface (10a) of the block (10) and penetrates entirely as illustrated in FIGS. 3 and 5, or partially as illustrated in FIG. 4 through the block (10). Accordingly, as a luminous device (13) disposed underneath the block (10) is triggered to emit light the letter/pattern is illuminated through the slot (11) for the user to use the mobile phone in the darkness.

A chamber (14) is provided in the lower portion of the block (10) as illustrated in FIG. 5 reflects the light emitted from the luminous device (13) disposed at the distal end of the block (10) through the slot (11) while achieving savings of material and production cost of the block (10).

The second material (20) filled in the slot (11) of the block (10) is of fluorescent material to automatically illuminate the push button in the darkness; alternatively, the second material (20) may be related to vitreous, transparent rubber and other materials pervious to light for the light emitted from the luminous device (13) in the block (10) to permit the light reflected through the second material (20). The second material (20) may be made in a color different than that of the block (10) to highlight the letter/pattern on the block (10) of the push button.

The present invention is characterized by that the letter/pattern assigned to each push button on a mobile phone is engraved into a slot (11) that entirely or partially penetrates through the block (10) of the push button and the slot (11) is then filled with a second material (20) to provide the following advantages and utilities:
1. With the second material (20) made of fluorescent material, the letter/pattern represented by the push button is displayed in the darkness.
2. The light emitted by the luminous device (13), e.g. an LED, installed in the mobile phone penetrates through the second material (20) that is pervious to light filled in the slot (11) clearly displays the letter/pattern assigned to the push button.
3. The product quality of the mobile phone provided with the push buttons of the present invention is improved. Whereas the letter/pattern is formed by the second material (20) filled in the slot (11) of the block (10), it will not be vulnerable to be, as found with the prior art stripped off or discolored after frequent use of the push buttons on a mobile phone.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A mobile phone push button that has a letter/pattern assigned to each push button engraved into a slot entirely penetrating through a block of the push button and the slot is filled with a second material.

2. The mobile phone push button of claim 1, wherein the push button is made of ceramic material.

3. The mobile phone push button of claim 1, wherein the push button is made of metal material.

4. The mobile phone push button of claim 1, wherein a tongue each respectively extends from both shorter sides of the block of the push button to be retained by a recess reserved on the mobile phone.

5. The mobile phone push button of claim 1, wherein the slot is made in a conic shape.

6. The mobile phone push button of claim 1, wherein a chamber is provided in the lower portion of the block of the push button.

7. The mobile phone push button of claim 1, wherein the second material is related to a fluorescent material.

8. The mobile phone push button of claim 1, wherein the second material is related to a material pervious to light.

9. The mobile phone push button of claim 1, wherein the color of the second material is different from that of the block of the push button.

10. A mobile phone push button that has a letter/pattern assigned to each push button engraved into a slot partially penetrating through a block of the push button and the slot is filled with a second material.

11. The mobile phone push button of claim 10, wherein the push button is made of ceramic material.

12. The mobile phone push button of claim 10, wherein the push button is made of metal material.

13. The mobile phone push button of claim 10, wherein a tongue each respectively extends from both shorter sides of the block of the push button to be retained by a recess reserved on the mobile phone.

14. The mobile phone push button of claim 10, wherein the slot is made in a conic shape.

15. The mobile phone push button of claim 10, wherein a chamber is provided in the lower portion of the block of the push button.

16. The mobile phone push button of claim 10, wherein the second material is related to a fluorescent material.

17. The mobile phone push button of claim 10, wherein the second material is related to a material pervious to light.

18. The mobile phone push button of claim 10, wherein the color of the second material is different from that of the block of the push button.
